(19) United States
(12) Patent Application Publication
(10) Pub. No.: US 2009/0004373 A1
(43) Pub. Date: Jan. 1, 2009

(54) Methods and Compositions for Temporary Barrier Coatings

(75) Inventors: Christian Rath, Crown Point, IN (US); Andrew P. Verrall, Crown Point, IN (US)

Correspondence Address: QUARLES & BRADY LLP, ONE SOUTH CHURCH AVENUE, SUITE 1700, TUCSON, AZ, 85701-1621, US

(73) Assignee: CASTLE DOME SOLUTIONS LLC, Yuma, AZ (US)

(21) Appl. No.: 12/146,980

(22) Filed: Jun. 26, 2008

Related U.S. Application Data
(60) Provisional application No. 60/946,306, filed on Jun. 26, 2007.

(51) Int. Cl. C09D 5/20; C08F 16/06; C08L 29/04; C08K 3/34

(52) U.S. Cl. 427/154; 526/319; 524/445; 524/557

(57) ABSTRACT

Methods of temporarily protecting an exterior surface of a structure, an interior hard surface, and an automobile part, including the step of applying to the surface a solution including a water-soluble polymer, and allowing the solution to dry, thereby forming a water-soluble polymer coating on the surface, is disclosed. The protective coating can thereafter be removed by washing the surface with water, such as with a power sprayer, taking with it any secondary substance which has coated it or otherwise has been bound to it.

### CROSS-REFERENCE TO RELATED APPLICATIONS

This application claims priority to U.S. Provisional Application No. 60/946,306, filed on Jun. 26, 2007, the entirety of which is hereby incorporated by reference herein for all purposes.

### BACKGROUND

1. Field of the Disclosure

The disclosure relates generally to temporary barrier coatings. More particularly, the disclosure relates to methods of using water-soluble polyvinyl alcohol as a temporary barrier coating to protect an underlying substrate.

2. Brief Description of Related Technology

To temporarily protect a substrate, such as aluminum or PVC siding, from unintentional marking with a paint or stain being applied nearby, a masking tape is typically used, either alone or in connection with a protective sheet made from paper, cloth, or preferably a liquid-impermeable material such as plastic or the like.

Similarly, to protect a hard surface in the home such as a kitchen table or hardwood floor from unintentional marking with paints, crayons, and the like, a paper or cardboard barrier is typically used.

Water-soluble polyvinyl alcohol (PVOH) polymers are known and used for creating self-supporting films by casting an aqueous solution of the polymer on a substrate such as a moving belt, drying off the water solvent, then stripping the film from the substrate and collecting it for later use. Water-soluble PVOH films are used for creating packets for unit-dose packaging and delivery of substances, such as laundry and dish detergents, into aqueous solutions.

### SUMMARY

One aspect of the disclosure provides a method of temporarily protecting an exterior surface of a structure, including the step of applying to the surface a solution including a water-soluble polymer, and allowing the solution to dry, thereby forming a water-soluble polymer coating on the surface.

Another aspect of the disclosure provides a method of temporarily protecting an interior hard surface, including the step of applying to the surface a solution including a water-soluble polymer, and allowing the solution to dry, thereby forming a water-soluble polymer coating on the surface.

Another aspect of the disclosure provides a method of temporarily protecting an automobile part surface, including the step of applying to the surface a solution including a water-soluble polymer, and allowing the solution to dry, thereby forming a water-soluble polymer coating on the surface.

Further aspects and advantages will be apparent to those of ordinary skill in the art from a review of the following detailed description. While the methods are susceptible of embodiments in various forms, the description hereafter includes specific embodiments with the understanding that the disclosure is illustrative, and is not intended to limit the invention to the specific embodiments described herein.

### DETAILED DESCRIPTION

Disclosed herein are methods and compositions for temporarily protecting various surfaces. The methods generally include the steps of applying to the surface to be protected a solution including a water-soluble polymer, and allowing the solution to dry, thereby forming a water-soluble polymer coating on the surface. The polymer coating will serve as a secondary surface (e.g., a second skin) for the substrate, which will deflect or bind secondary substances which would otherwise contaminate the protected surface. The protective coating can thereafter be removed by washing the surface with water, such as with a power sprayer, taking with it any secondary substance which has coated it or otherwise has been bound to it. The water-soluble coating can be removed by simple flushing or power washing, or a cloth or chamois can be used, and later washed free of the polymer solution and any secondary substance.

The methods and compositions are contemplated to include embodiments including any combination of one or more of the additional optional elements, features, and steps further described below, unless stated otherwise.

The methods described herein are not limited to use for protection against any particular substances. The methods are contemplated for protection against any substance, preferably marking and staining substances. Common marking and staining substances include liquids, including aqueous and non-aqueous liquids, e.g., in bulk or aerosol form, and solids, including fine particulate solids. Additional particular common substances are described herein in connection with the preferred embodiments. In another embodiment, the method can also be used to protect a surface against non-marking substances, such as corrosive gases, radiation (e.g., ultraviolet radiation), and the like.

The temporary protection for exterior applications will generally last until a natural rainfall or until water is applied to the protected surface. The temporary protection for internal applications will generally last until the surface protection is no longer needed (e.g., until the activity protected against ceases). In general, it is contemplated that the temporary protection will last for a time period up to several weeks, e.g., two months or less, and in some embodiments will be on the order of days or hours, e.g., 2 days, 1 day, 18 hours, 12 hours, 6 hours, or until the activity protected against ceases.

Thus, the method can optionally include the steps of applying (albeit inadvertently or incidentally) a secondary substance to the water-soluble coating, and removing the water-soluble coating (e.g., by peeling or preferably by washing).

In a first embodiment, the surface to be protected is an external part of a structure (e.g., of a residential or commercial building). The surface can be one such as, but not limited to, one or more of stone, brick, concrete, siding (e.g., steel siding, fiber cement siding, aluminum siding, vinyl siding, and wood siding). For example, the method can be used when one portion of the structure is being painted, and adjacent portion of the building is not intended for painting. Similarly, the method can be used when something adjacent to the structure is being painted or stained, for example, and it is desired to protect the structure from inadvertently applied paint or stain. The method is not limited to use for protection against paints and stains, and instead protection from any marking substance is contemplated, including agents which can inadvertently contact the building in the form of aerosols and fine particulates.

This method is particularly advantageous in that prior schemes have typically involved the use of an adhesive-backed material such as tape to either provide a primary barrier or to affix a barrier material such as plastic sheeting, whereas structures such as buildings and the like often have residual surface dirt which frustrates successful application of an adhesive tape. Coating such a surface with a water-soluble polymer solution can be done easily and successfully.

In another embodiment, the surface to be protected is an interior hard surface (e.g., of a floor, wall, or countertop), such as in a residence. The hard surface is not limited to any particular material, and will preferably be one which is easily cleaned with water. The substance can be, for example, wood, stone, metal, and synthetic laminates. For example, the methods can be used to protect a countertop or table from inadvertent marking with crayons, pens, markers, or the like. Similarly, the method can be used to protect such surfaces from liquid substances such as paints and dyes, such as Easter egg dyes. The method is not limited to use for protection against crayons, paints and dyes, and instead protection from any marking substance is contemplated.

In a third embodiment, the surface to be protected is an automobile wheel part surface, e.g., of a wheel, rim, or hubcap. For examples, the method can be used to protect rims and hubcaps from brake dust, road dirt, and paving tar.

In a fourth embodiment, the surface to be protected is an automobile part surface, e.g., of a bumper, fender or underbody. For example, the method can be used to protect body panels from road tar.

The solution for application generally includes water, a water-soluble polymer such as polyvinyl alcohol (PVOH), derivatives thereof, and combinations of water soluble polymers, and any optional additives. The method can involve use of a polymer emulsion in one embodiment, and in another embodiment the solution is a single-phase solution. In one embodiment the polymer will consist essentially of, or consist only of, PVOH and/or a copolymer thereof. Preferably, the polymer will consist essentially of, or consist only of, PVOH. If polyvinyl alcohol or a copolymer thereof is used, then the PVOH can be partially or fully hydrolyzed. Polyvinyl alcohol (PVOH) is a synthetic resin generally prepared by the alcoholysis, usually termed hydrolysis or saponification, of polyvinyl acetate.

Fully hydrolyzed PVOH, where virtually all the acetate groups have been converted to alcohol groups (e.g., 98% or greater degree of hydrolysis), is a strongly hydrogen-bonded, highly crystalline polymer which dissolves only in hot water—e.g., rapid dissolution at temperatures of about 60° C. and greater.

If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water—e.g., rapid dissolution at temperatures of about 10° C. and greater. Cold-water soluble polymers are preferred.

Both fully and partially hydrolyzed PVOH types are commonly referred to as PVOH homopolymers although the partially hydrolyzed type is technically a vinyl alcohol-vinyl acetate copolymer.

An intermediate cold/hot water soluble polymer can include, for example, blends of partially-hydrolyzed PVOH (e.g., with degrees of hydrolysis of about 94% to about 98%), and is readily soluble only in warm water—e.g., rapid dissolution at temperatures of about 40° C. and greater.

The term PVOH copolymer is generally used to describe polymers that are derived by the hydrolysis of a copolymer of a vinyl ester, typically vinyl acetate, and another monomer. PVOH copolymers can be tailored to desired film characteristics by varying the kind and quantity of copolymerized monomers. Examples of copolymerizations are those of vinyl acetate with a carboxylic acid or with an ester of a carboxylic acid. Again, if the hydrolysis of acetate groups in these copolymers is only partial, then the resulting polymer could also be described as a PVOH terpolymer—having vinyl acetate, vinyl alcohol, and carboxylic acid groups—although it is commonly referred to as a copolymer.

The water-soluble polymer preferably is selected to provide a 4% solution viscosity in a range of about 5 cP to about 40 cP at 20° C., more preferably about 10 cP to about 30 cP at 20° C.

The method and solution are contemplated to include embodiments including any combination of one or more of the additional optional elements, features, and steps further described below, unless stated otherwise.

In one type of embodiment, the solution preferably is essentially free of crosslinking agents, or completely free of crosslinking agents for the water-soluble polymer. In another type of embodiment, only a small amount of a weak crosslinking agent will be used.

For PVOH as the water-soluble polymer, crosslinking agents can be selected from any chemical agent that can form chemical bonds with the hydroxyl groups of PVOH. Such crosslinking agents include, for example, monoaldehydes (e.g., formaldehyde and hydroxyacetaldehyde), dialdehydes (e.g., glyoxal, glutaraldehyde and succinic dialdehyde), aldehyde-containing resins (e.g., trimethylol melamine), dicarboxylic acids (e.g., maleic, oxalic, malonic and succinic acids), citric acid, glycidyl and other difunctional methacrylates, N-lactam carboxylates, dithiols (e.g., m-benzodithiol), boric acid and borates, ammonium zirconium carbonate, inorganic polyions (e.g., molybdate and tungstate), cupric salts and other Group 1B salts, and polyamide-epichlorohydrin resin (polyazetidine prepolymer).

Rather than those crosslinking agents which undergo direct condensation reactions with hydroxyl groups (such as esterification and acetalization reactions with carboxylic acids and aldehydes, respectively), preferred crosslinking agents—for reasons of solution stability and rheology—are those that have one or more of the following functionalities: those that form complexes via labile polar covalent interactions, those that crosslink via ionic interactions, those that crosslink via hydrogen bonding interactions, and combinations of such crosslinking agents. Examples of such preferred crosslinking agents are borates, boric acid, ammonium zirconium carbonate, inorganic polyions such as molybdate and tungstate, cupric salts and other Group 1 B salts, and polyamide-epichlorohydrin resin, and combinations thereof. Water-soluble polyamide-epichlorohydrin is available under the trade name POLYCUP 172 by Hercules, Inc. of Wilmington, Del. A particularly preferred crosslinking agent for PVOH is boric acid.

The crosslinking agent, when used, is present in an amount of less than 5 wt. %, based on the weight of the water-soluble polymer, such as PVOH. In addition, or in an alternative embodiment, the crosslinking agent, when used, is present in an amount of less than 0.5 wt. %, based on the weight of the solution.

The solution can optionally include a plasticizer. The plasticizer aids in making the coating more flexible and, thus, less subject to fracture. Glycerin is a preferred plasticizer. With PVOH, for example, in preferred embodiments glycerin is used in an amount from about 5 percent by weight (wt. %) to about 40 wt. % of the solution, on a dry basis. Other plasticizers suitable for use with PVOH are known in the art and are contemplated for use in the solution described herein.

The solution can optionally include a surfactant. The surfactant can aid in wetting out of the solution on a substrate, and penetration into a porous substrate. Suitable surfactants may include the nonionic, cationic, anionic and zwitterionic classes. Preferably, the surfactants will be of the nonionic, cationic or zwitterionic classes or combinations of these. Suitable surfactants include, but are not limited to polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Preferred surfactants are alcohol ethoxylates, quaternary ammonium salts and amine oxides. Preferably, the surfactant has a hydrophile-lipophile balance (HLB) of 10 or greater, more preferably greater than 10.

The solution can optionally include a tackifying agent. The tackifying agent can aid in sequestering particulate matter. Tackifying agents generally fall into three classes: rosin resins and rosin esters, hydrocarbon resins including hydrogenated hydrocarbon resins, and terpine resins. A suitable tackifying agent can be selected from the AQUATAC family of rosin esters, such as AQUATAC 6085 rosin ester, which is available from Arizona Chemical Co. as a dispersion of 60% solids. The tackifying agent preferably is included in an amount from about 1/100% to 1%, based on the weight of the water-soluble polymer.

The solution can optionally include nanoclays or other nanoscale particulate materials. The nanoparticulates, much like crosslinking agents, can enhance water resistance and strength of a coating film formed from the polymer solution. Suitable nanoscale particulate materials include natural layered silicate materials (clays), including the smectite family of nonoclays, synthetic layered silicates (e.g., LAPONITE clay, available from Laporte Industries Plc, UK), nanocrystalline main group metal oxides, nanocrystalline rare earth oxides, nanocrystalline transition metal oxides, nanocrystalline mixed oxides of the foregoing; nanocrystalline main group metal phosphates and phosphonates, nanocrystalline transition metal phosphates and phosphonates, and nanocrystalline alkaline earth metal phosphates and phosphonates; nanocrystalline chalcogenide compounds; nanocrystalline fullerene aggregates, and combinations of any of the foregoing.

Preferred are hydrophilic nanoclays that are selected from the smectite family of nanoclays (e.g., aliettite, beidellite, hectorite, montmorillonite, nontronite, saponite, sauconite, stevensite, swinefordite, volkonskoite, yakhontovite, and zincsilite). More preferred is a montmorillonite such as sodium montmorillonite. Sodium montmorillonite is available under the trade name CLOISITE NA from Southern Clay Products, Inc., of Gonzales, Tex. The nanoscale particulate material preferably is included in an amount from about 2 wt. % to about 5 wt. % of the solution on a dry basis.

In one type of embodiment, the solution can include a color agent, which can serve as an indicator for application or as a masking agent. Colorants are known which remain colored in aqueous solution and which become clear upon drying. Absent a colorant, on many substrates the applied coating will not be evident by visual inspection.

In general, any suitable concentration of the solution described herein can be used, and potentially will vary depending on the apparatus used for application. For example, concentrations in the range of about 0.01 wt. % solids to about 20 wt. % solids are contemplated. In one embodiment, the solution of water-soluble polymer and optional additives preferably has a solids content in a range of about 1 wt. % to about 16 wt. %, or 4 wt. % to about 12 wt. %.

The solution can be created by dissolving a solids mixture including the water-soluble polymer into water, or by diluting a prepared concentrated solution. Preferred forms of the solids mixture of components include spray-dried powders, pelletized solids, and flaked solids. The solids can be provided in a water-soluble bag made from the same or a different water-soluble polymer, which can then easily be dissolved at the point of use to yield a suitable solution.

In one embodiment, the rate of application of the solution preferably is such that it yields at least a 3 mil (0.003 inch; 0.0762 mm) layer of coating polymer, such as 0.1 mm, 0.15 mm, or 0.2 mm. In another embodiment, the rate of application of the solution preferably is such that it yields 0.10 g/m² to 150 g/m², on a dry basis, preferably 10 g/m² to 150 g/m² or 50 g/m² to 150 g/m² on the surface.

The coating solution can be applied in any desired manner, such as with a brush, a roller, a hand sprayer (e.g., a trigger spray applicator), and a venturi induction sprayer (e.g., while diluting with water). The solution can be applied in a single application step, or with multiple application steps to yield the desired thickness of coating polymer. When more than one application step is performed, each reapplication step can be performed prior to the preceding application substantially drying, or preferably after the preceding application has substantially dried.

In one embodiment, the solution is applied in such a manner as to yield a fine mist comprising substantially discrete droplets of solution, rather than flooding the surface with solution, which tends to cause runoff. Application of a fine mist can be achieved with a spray apparatus, according to methods known in the art. Preferably, a spray apparatus will be positioned and operated to avoid driftage and runoff.

A fine droplet size of solution during application is especially preferred with solutions having relatively high concentration of polymer (e.g., 4 wt. % to 12 wt. %). A relatively high viscosity solution (e.g., 1000 cP) is preferably diluted (e.g., to about 1 wt. % to about 8 wt. % polymer, such as 4 wt. % polymer) to yield a solution viscosity close to water (e.g., 1 cP to 40 cP).

Various embodiments of the method and solution described herein can optionally yield one or more advantages. For example, the method described herein provides a solution which is convenient and easy to apply, which reduces waste, and which provides effective protection of any underlying substrate. Application equipment can be washed out by water; no organic thinners are necessary, and equipment is not corroded by the solution. The solution is non-toxic, and skin contact is not hazardous.

### EXAMPLE

The following example is provided for illustration and ise not intended to limit the scope of the invention.

A 16 wt. % solution of water-soluble polymer containing PVOH, plasticizers including glycerin, surfactants, and other minor components including starch, was applied by brush to a section of residential aluminum siding attached to a residence, and by spraying onto another section of residential aluminum siding. The coating solution was allowed to dry, and then consumer grade deck stain was used to stain an adjacent wood deck. Some stain incidentally contacted the residence in the regions where the siding had been coated with the PVOH solution. After the deck stain had dried, the protective coating was washed from the aluminum siding, taking with it the staining composition which had adhered to it.

The foregoing description is given for clearness of understanding only, and no unnecessary limitations should be understood therefrom, as modifications within the scope of the invention may be apparent to those having ordinary skill in the art.

Throughout the specification, where compositions are described as including components or materials, it is contemplated that the compositions can also consist essentially of, or consist of, any combination of the recited components or materials, unless described otherwise.

The practice of a method disclosed herein, and individual steps thereof, can be performed manually and/or with the aid of automated and electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

All patents, publications and references cited herein are hereby fully incorporated by reference. In case of conflict between the present disclosure and incorporated patents, publications and references, the present disclosure should control.

What is claimed is:

1. A method for providing a temporary barrier coating, comprising the step of:
applying a water-soluble polyvinyl alcohol solution to a surface of a substrate, thereby forming a protective coating at said surface top.

2. The method of claim 1, further including the step of allowing said solution to dry.

3. The method of claim 2, further including the step of contacting said solution with a secondary substance.

4. The method of claim 2, further including the step of removing said solution at a time after said solution dries.

5. The method of claim 3, further including the step of removing said solution at a time after said contact with said secondary substance.

6. The method of claim 4, wherein said removing comprises use of a power sprayer.

7. The method of claim 1, wherein said solution contains a color agent that renders the solution a different color from the surface color.

8. The method of claim 1, wherein said solution is applied without prior cleaning or other preparation of the surface of said substrate.

9. A composition, comprising:
a water-soluble polyvinyl alcohol or copolymer thereof adhered to a substrate top.

10. The composition of claim 9, wherein said polyvinyl alcohol is partially hydrolyzed.

11. The composition of claim 9, wherein said polyvinyl alcohol is essentially free of crosslinking agents.

12. The composition of claim 9, further including a plasticizer in combination with said polyvinyl alcohol.

13. The composition of claim 9, further including a surfactant in combination with said polyvinyl alcohol.

14. The composition of claim 9, further including a tackifying agent in combination with said polyvinyl alcohol.

15. The composition of claim 9, further including a nanoclay or nanoscale particulate in combination with said polyvinyl alcohol.

16. The composition of claim 10, further including a color agent in combination with said polyvinyl alcohol.
